(19) United States
(12) Patent Application Publication
(10) Pub. No.: US 2022/0293315 A1
(43) Pub. Date: Sep. 15, 2022

(54) Internally Embedded Copper Plate-Type Soft Magnetic Powder Core Inductor, Preparation Method Therefor, and Use Thereof

(71) Applicants: Shenzhen Boke New Material Co., Ltd., Guangdong (Nanshan District Shenzhen) (CN); Huizhou Poco Magnetic Co., Ltd., Guangdong (CN); Huizhou Boke Industry Co., Ltd., Guangdong (CN)

(72) Inventors: Yunfan Zhang, Guangdong (CN); Xiongzhi Guo, Guangdong (CN); Qiang Xiao, Guangdong (CN); Guohua Wang, Guangdong (CN); Yixuan Li, Guangdong (CN); Kai He, Guangdong (CN); Xuemin Chen, Guangdong (CN); Jialin Ruan, Guangdong (CN); Yunkai Cao, Guangdong (CN); Zhengping Li, Guangdong (CN)

(73) Assignees: Shenzhen Boke New Material Co., Ltd., Guangdong (Nanshan District Shenzhen) (CN); Huizhou Poco Magnetic Co., Ltd., Guangdong (CN); Huizhou Boke Industry Co., Ltd., Guangdong (CN)

(21) Appl. No.: 17/631,341

(22) PCT Filed: Jun. 30, 2020
(86) PCT No.: PCT/CN2020/099228

§ 371 Date: Jun. 2, 2022

(30) Foreign Application Priority Data
Jan. 17, 2020 (CN) 202010052363.5

(51) Int. Cl. H01F 1/26; H01F 27/255; H01F 27/245; H01F 41/02; H01F 1/147

(52) U.S. Cl. CPC H01F 1/26; H01F 27/255; H01F 27/245; H01F 41/0246; H01F 1/14758; H01F 1/14791

(57) ABSTRACT

The present application relates to an internally embedded copper plate-type soft magnetic powder core inductor, a preparation method therefor, and a use thereof. The internally embedded copper plate-type soft magnetic powder core inductor comprises a copper plate, a surface of the copper plate is covered with a soft magnetic material, and an interfacing area of the soft magnetic material and the copper plate includes an insulating resin material. The internally embedded copper plate-type soft magnetic powder core inductor possesses high density, high magnetic core magnetic permeability, high inductance, high saturated magnetic flux density, low volume, and low magnetic flux leakage, if said powder core inductor is used to replace a ferrite inductor of a same inductance for a low voltage DC/DC converter circuit, the same or greater efficiency can be achieved, and inductor volume can be reduced by at least half; the withstand voltage of the internally embedded copper plate type soft magnetic powder core inductor can reach over 15V, and the preparation method for said inductor is simple, possessing high production efficiency and suitable for large-scale automated production.

### TECHNICAL FIELD

The present application belongs to the field of electronic technologies and relates to a copper sheet-embedded soft magnetic powder core inductor, a method for preparing the same, and a use thereof.

### BACKGROUND

In recent years, with the rapid development of semiconductor devices, the requirements of inductors have evolved towards high efficiency, low inductance, miniaturization, and large currents. Accordingly, soft magnetic materials are required to have a low loss, high permeability and a high saturation magnetic flux density. At present, common inductors include integrally-molded inductors and ferrite inductors.

An integrally-molded inductor is made in a manner that magnetic metal powder and a resin are mixed and integrally molded with a metal coil and has the advantages of an ability to cope with large currents and miniaturization. However, compared with a ferrite inductor, the integrally-molded inductor is difficult to achieve high permeability and reach required inductance due to the disadvantages of a small pressing pressure and a small ratio in volume of metal powder. Therefore, a coil has to be added to increase inductance, resulting in a relatively large inductor DCR and a relatively large copper loss. Regardless of high permeability, the ferrite inductor has a small saturation magnetic flux density, and an air gap is required to prevent saturation, thus resulting in related problems such as magnetic leakage. During its use, undesirable phenomena such as an increase of a local temperature and low loop efficiency are likely to occur. In addition, the large size of the ferrite inductor is also one of the key factors limiting the application of the ferrite inductor.

CN107768069A has disclosed an inductor and a manufacturing method thereof. The manufacturing method of the inductor includes the following steps: in S 1, a magnetic core is manufactured: pelleting magnetic powder is pressed into a high-density block body, and then the high-density block body is cut into a magnetic core structure which is sintered into a compact state, where the magnetic core includes a middle post and two swinging blades; in S2, a coil is wound: a coil is wound on the middle post, where after winding, the cross section of the coil is enabled to be parallel to the long and high plane of the inductor, and two leading-out ends of the coil are positioned at two sides of the middle post and are positioned on the same plane; in S3, compression molding is carried out: the bottom of a mold is filled with a layer of pelleting magnetic powder for prepressing compaction, the magnetic core wound with the coil in the step S2 is implanted into the mold, and after implantation, the mold is fully filled with the pelleting magnetic powder for compression molding; in S4, a semi-finished product is subjected to heat treatment; in S5, terminal electrodes are manufactured. The inductor obtained through this solution has the problems of low inductance, a low magnetic flux density, and a large loss due to a small pressing pressure and a low heat treatment temperature.

CN107275045A has disclosed a method for manufacturing an inductor and a method for preparing a plastic package material of the inductor. The method for preparing the plastic package material of the inductor includes steps of uniformly mixing 60-90 wt % of a powdery material and 10-40 wt % of an epoxy resin, pressing the mixed material into a spherical material, and placing the spherical material in an environment of −5° C. to 0° C. to refrigerate the spherical material so that the plastic package material of the inductor is obtained. The powdery material is one or more of a nickel zinc ferrite powdery material, a manganese zinc ferrite powdery material, an iron silicon chromium powdery material and an iron silicon aluminum powdery material. The method for manufacturing the inductor includes steps of making a magnetic core twined by an enameled copper wire welded to a lead box and then adopting the plastic package material to conduct injection-package, so that the inductor is manufactured and obtained. The inductor obtained through this solution has the problems of a low magnetic flux density and a large loss due to a small proportion of soft magnetic powder and a small molding pressure.

Therefore, it is still of great significance to develop an inductor with a high saturation magnetic flux density, high inductance, and a small size, which can be applicable to a low-voltage DC/DC converter circuit with high efficiency.

### SUMMARY

The following is a summary of the subject matter described herein in detail. This summary is not intended to limit the protection scope of the claims.

The object of the present application is to provide a copper sheet-embedded soft magnetic powder core inductor, a method for preparing the same, and a use thereof. The copper sheet-embedded soft magnetic powder core inductor includes a copper sheet, a soft magnetic material covered on a surface of the copper sheet, and an insulating resin material contained on an interface between the copper sheet and the soft magnetic material. The copper sheet-embedded soft magnetic powder core inductor has the characteristics of a high density, high magnetic core permeability, high inductance, a high saturation magnetic flux density, a small size, and less magnetic leakage and can achieve the same efficiency or higher efficiency and reduce a volume of the inductor by half or more when it is applicable to a low-voltage DC/DC converter circuit instead of a ferrite inductor with the same inductance. The copper sheet-embedded soft magnetic powder core inductor of the present application can reach a withstand voltage higher than 15 V. Moreover, the copper sheet-embedded soft magnetic powder core inductor of the present application is prepared by a simple method, produced with high efficiency, and suitable for large-scale automatic production.

To achieve the object, the present application adopts technical solutions described below.

In a first aspect, the present application provides a copper sheet-embedded soft magnetic powder core inductor. The copper sheet-embedded soft magnetic powder core inductor includes a copper sheet, a soft magnetic material covered on a surface of the copper sheet, and an insulating resin material contained on an interface between the copper sheet and the soft magnetic material.

The copper sheet-embedded soft magnetic powder core inductor of the present application has a high saturation magnetic flux density and can cope with large currents (30 A to 100 A), greatly reduce the volume of the inductor, and avoid the problem of magnetic leakage due to an opened air gap.

The copper sheet-embedded soft magnetic powder core inductor of the present application has the characteristics of high inductance. Compared with traditional integrally-molded inductors, the copper sheet-embedded soft magnetic powder core inductor can reduce the number of windings, the volume of the inductor, and the loss of the inductor. The copper sheet-embedded soft magnetic powder core inductor can achieve the same inductance as the ferrite inductor by using only one copper sheet.

Optionally, two ends of the copper sheet are not covered by the soft magnetic material, where the two ends are any two opposite ends.

Optionally, a length-to-width ratio of the copper sheet is 8:1 to 10:1, for example, 8.5:1, 9:1, or 9.5:1.

Optionally, the insulating resin material includes an organosilicon resin material.

The organosilicon resin material here is a high temperature-resistant organosilicon resin material, where “high temperature-resistant” refers to thermal stability at a temperature higher than 550° C., such as 560° C., 580° C., 600° C., or 650° C. For example, the high temperature-resistant organosilicon resin material includes organosilicon resin SILRES® REN 60.

Optionally, the soft magnetic material is obtained through soft magnetic metal powder subjected to press molding.

Optionally, the press molding is carried out at a pressure of 12-18 T/cm², such as 13 T/cm², 14 T/cm², 15 T/cm², 16 T/cm², or 17 T/cm².

Optionally, the soft magnetic material in the copper sheet-embedded soft magnetic powder core inductor has a density of 5.5-6.5 g/cm³, such as 5.6 g/cm³, 5.7 g/cm³, 5.8 g/cm³, 5.9 g/cm³, 6.1 g/cm³, or 6.3g/cm³.

Compared with traditional ferrite inductors, the copper sheet-embedded soft magnetic powder core inductor of the present application has a higher density and a higher saturation magnetic flux density, so that the copper sheet-embedded soft magnetic powder core inductor can cope with larger currents and reduce the volume by 50% or more.

Optionally, the soft magnetic material covers regions that are symmetrical on two sides of the copper sheet.

Optionally, the soft magnetic material is symmetrically distributed on two sides of the copper sheet.

Here, “symmetrically distributed” refers to that the soft magnetic material has exactly the same length, width and thickness on the two sides of the copper sheet and covers regions that are symmetrical about the copper sheet.

Optionally, the soft magnetic metal powder includes any one or a combination of at least two of iron powder, iron-silicon powder, iron-silicon-aluminium powder, iron-nickel powder, or iron-nickel-molybdenum powder. The combination exemplarily includes a combination of the iron powder and the iron-silicon powder, a combination of the iron-silicon-aluminium powder, the iron-nickel powder and the iron-nickel-molybdenum powder, or the like.

In a second aspect, the present application provides a method for preparing the copper sheet-embedded soft magnetic powder core inductor described in the first aspect. The method includes the following steps:

(1) coating an insulating resin material on a surface of a copper sheet, baking and curing; and

(2) placing the copper sheet coated with the insulating resin material and obtained in step (1) in soft magnetic metal powder, press molding, and annealing in an inert atmosphere to obtain the copper sheet-embedded soft magnetic powder core inductor.

In the process of preparing the copper sheet-embedded soft magnetic powder core inductor of the present application, the surface of the copper sheet is coated with the insulating resin material, press molded in the soft magnetic metal powder, and annealed so that the copper sheet-embedded soft magnetic powder core inductor is obtained. The method of press molding can effectively increase the density of the prepared inductor and the volume ratio of the magnetic material, thereby increasing the permeability and inductance, reducing the number of windings and reducing a copper loss of the prepared copper sheet-embedded soft magnetic powder core inductor. In addition, the copper sheet is pressed inside the soft magnetic metal powder, which helps to reduce the volume of the inductance and the magnetic leakage.

The method of the present application embeds the copper sheet into the soft magnetic metal powder and then carries out press molding. The method has a simple preparation process, is beneficial to improving production efficiency, and is suitable for large-scale automatic production.

Optionally, the insulating resin material in step (1) includes an organosilicon resin material.

Optionally, the soft magnetic metal powder in step (2) includes any one or a combination of at least two of iron powder, iron-silicon powder, iron-silicon-aluminium powder, iron-nickel powder, or iron-nickel-molybdenum powder. The combination exemplarily includes a combination of the iron powder and the iron-silicon powder, a combination of the iron-silicon-aluminium powder, the iron-nickel powder and the iron-nickel-molybdenum powder, or the like.

Optionally, the soft magnetic metal powder in step (2) has an average particle size of 2-25 μm, such as 5 μm, 8 μm, 10 μm, 15 μm, 20 μm, or 25 μm.

Optionally, the press molding in step (2) is carried out at a pressure of 12-18 T/cm², such as 13 T/cm², 14 T/cm², 15 T/cm², 16 T/cm², or 17 T/cm².

Optionally, the annealing in step (2) is carried out at a temperature of 550-700° C., such as 580° C., 600° C., 620° C., 650° C., or 680° C.

Optionally, the annealing in step (2) is carried out for 1-3 h, such as 1.5 h, 2 h, or 2.5 h.

Optionally, the inert atmosphere is nitrogen.

As an optional technical solution of the present application, the method for preparing the copper sheet-embedded soft magnetic powder core inductor includes the following steps:

(1) coating an organosilicon resin material on a surface of a copper sheet, baking and curing; and

(2) placing the copper sheet coated with the organosilicon resin material and obtained in step (1) in soft magnetic metal powder with an average particle size of 10 μm, press molding at a pressure of 12-18 T/cm² to obtain a molded body, and placing the molded body in an annealing furnace for annealing at 550-700° C. in an inert atmosphere for 1-3 hours to obtain the copper sheet-embedded soft magnetic powder core inductor.

In a third aspect, the present application provides a use of the copper sheet-embedded soft magnetic powder core inductor described in the first aspect. The copper sheet-embedded soft magnetic powder core inductor is used in a low-voltage DC/DC converter circuit.

Compared with the existing art, the present application has beneficial effects described below.

(1) The copper sheet-embedded soft magnetic powder core inductor of the present application includes a copper sheet, a soft magnetic material covered on a surface of the copper sheet, and an insulating resin material contained on an interface between the copper sheet and the soft magnetic material. Compared with the traditional ferrite inductor, the copper sheet-embedded soft magnetic powder core inductor has the advantages of a high magnetic flux density, a small size, and no magnetic leakage due to an opened air gap.

(2) The copper sheet-embedded soft magnetic powder core inductor of the present application is applicable to a low-voltage DC/DC converter circuit. Compared with traditional ferrite inductors, the copper sheet-embedded soft magnetic powder core inductor can achieve the same efficiency or higher efficiency, reduce the volume by half or more, and reach a withstand voltage higher than 15 V.

(3) The copper sheet-embedded soft magnetic powder core inductor of the present application is prepared by a simple method, beneficial to significantly improving production efficiency, and suitable for large-scale automatic production.

Other aspects can be understood after the detailed description and the drawings are read and understood.

### BRIEF DESCRIPTION OF DRAWINGS

FIG. 1 is a structure diagram of the copper sheet-embedded soft magnetic powder core inductor of the present application.

### DETAILED DESCRIPTION

The technical solutions of the present application are further described below through the detailed description. Those skilled in the art are to understand that examples described herein are merely used for a better understanding of the present application and are not to be construed as specific limitations to the present application.

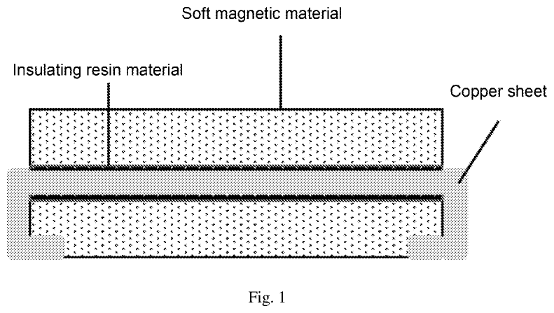

A structure diagram of the copper sheet-embedded soft magnetic powder core inductor is shown in FIG. 1. As can be seen from FIG. 1, the copper sheet-embedded soft magnetic powder core inductor includes a copper sheet, a soft magnetic material covered on a surface of the copper sheet, and an insulating resin material contained on an interface between the copper sheet and the soft magnetic material. The soft magnetic material is symmetrically distributed on two sides of the copper sheet, and two ends of the copper sheet are not covered by the soft magnetic material. As shown in FIG. 1, regions of the copper sheet that are not covered by the soft magnetic material are bent as shown in FIG. 1.

### Example 1

A method for preparing a copper sheet-embedded soft magnetic powder core inductor includes the following steps:

(1) organosilicon resin SILRES® REN 60 was coated evenly on a surface of a copper sheet with a thickness of 0.3 mm and a width of 2.5 mm and baked until it was cured; and

(2) the copper sheet treated in step (1) was embedded into magnetic iron-silicon-aluminium powder with an average particle size of 15 μm and press molded at a pressure of 16 T/cm² so that there was obtained a molded body with a length of 14 mm, a width of 5 mm, and a height of 2 mm; then, the molded body was placed in an annealing furnace and annealed at 680° C. for 120 minutes in a nitrogen atmosphere so that the copper sheet-embedded soft magnetic powder core inductor was obtained.

The size of the molded body includes the size of the soft magnetic material and the size of the copper sheet embedded in the soft magnetic material.

### Example 2

A method for preparing a copper sheet-embedded soft magnetic powder core inductor includes the following steps:

(1) organosilicon resin SILRES® REN 60 was coated evenly on a surface of a copper sheet with a thickness of 0.25 mm and a width of 2.5 mm and baked until it was cured; and

(2) the copper sheet treated in step (1) was embedded into magnetic iron-silicon-aluminium powder with an average particle size of 15 μm and press molded at a pressure of 12 T/cm² so that there was obtained a molded body with a length of 14 mm, a width of 5 mm, and a height of 2 mm; then, the molded body was placed in an annealing furnace and annealed at 680° C. for 120 minutes in a nitrogen atmosphere so that the copper sheet-embedded soft magnetic powder core inductor was obtained.

### Example 3

A method for preparing a copper sheet-embedded soft magnetic powder core inductor includes the following steps:

(1) organosilicon resin SILRES® REN 60 was coated evenly on a surface of a copper sheet with a thickness of 0.3 mm and a width of 2.7 mm and baked until it was cured; and

(2) the copper sheet treated in step (1) was embedded into magnetic iron-silicon-aluminium powder with an average particle size of 10 μm and press molded at a pressure of 18 T/cm² so that there was obtained a molded body with a length of 14 mm, a width of 5 mm, and a height of 2 mm; then, the molded body was placed in an annealing furnace and annealed at 680° C. for 120 minutes in a nitrogen atmosphere so that the copper sheet-embedded soft magnetic powder core inductor was obtained.

### Example 4

This example differs from Example 1 in that the annealing temperature was changed from 680° C. to 550° C., and other conditions were exactly the same as those of Example 1.

### Example 5

This example differs from Example 1 in that the annealing temperature was changed from 680° C. to 450° C., and other conditions were exactly the same as those of Example 1.

### Example 6

This example differs from Example 1 in that the annealing temperature was changed from 680° C. to 800° C., and other conditions were exactly the same as those of Example 1.

### Example 7

This example differs from Example 1 in that the average particle size of the magnetic iron-silicon-aluminium powder in step (2) was changed from 10 μm to 2 μm, and other conditions were exactly the same as those of Example 1.

### Example 8

This example differs from Example 1 in that the average particle size of the magnetic iron-silicon-aluminium powder in step (2) was changed from 10 μm to 20 μm, and other conditions were exactly the same as those of Example 1.

### Example 9

This example differs from Example 1 in that the magnetic iron-silicon-aluminium powder in step (2) was replaced with iron-nickel powder with the same average particle size, and other conditions were exactly the same as those of Example 1.

### Example 10

This example differs from Example 1 in that the magnetic iron-silicon-aluminium powder in step (2) was replaced with iron-nickel-molybdenum powder with the same average particle size, and other conditions were exactly the same as those of Example 1.

### Comparative Example 1

This comparative example uses a ferrite inductor with the same inductance as the copper sheet-embedded soft magnetic powder core inductor in Example 1. The size of the ferrite inductor is 14 mm in length, 5 mm in width, and 8 mm in height. The ferrite inductor was prepared by the following method: two pieces of ferrite with a groove of 14 mm×5 mm×4 mm were made, where the groove has a depth of 1.7 mm, the two pieces of ferrite were buckled up and down, and a copper sheet was penetrated through the groove and bent so that the required ferrite inductor was obtained.

Performance Test

The density, volume and inductance of each of the copper sheet-embedded soft magnetic powder core inductors prepared in Examples 1 to 10 and the ferrite inductor in Comparative Example 1 were tested. Efficiency was tested when they were applied to low-voltage DC/DC converter circuits. Test results are shown in Table 1. The volume of the copper sheet-embedded soft magnetic powder core inductor refers to the sum of the volume of the molded body and the volume of the copper sheet uncovered by the soft magnetic material.

Test conditions were a frequency of 700 kHz, a current of 40 A, and a voltage of 1 V when they were applied to the low-voltage DC/DC converter circuits.

The insulation withstand voltages of the copper sheet-embedded soft magnetic powder core inductors prepared in Examples 1 to 10 and the ferrite inductor in Comparative Example 1 were tested. Test results are shown in Table 1.

TABLE 1

| | | | | | Insulation |
|---|---|---|---|---|---|
| | Density | inductance | Volume | Efficiency | Resistance |
| | (g/cm³) | (nH) | (mm³) | (%) | (kΩ, 15 V) |
| Example 1 | 5.7 | 138 | 146 | 87.2 | 50 |
| Example 2 | 5.62 | 126 | 145 | 86.5 | 51 |
| Example 3 | 5.73 | 135 | 146 | 87.3 | 52 |
| Example 4 | 5.71 | 138 | 146 | 87.1 | 55 |
| Example 5 | 5.7 | 137 | 146 | 86.5 | 50 |
| Example 6 | 5.71 | 132 | 146 | 85.1 | 35 |
| Example 7 | 5.51 | 122 | 146 | 86.5 | 51 |
| Example 8 | 5.75 | 142 | 146 | 87.1 | 51 |
| Example 9 | 6.3 | 125 | 146 | 86.5 | 45 |
| Example 10 | 6.5 | 127 | 146 | 86.3 | 48 |
| Comparative | 4.5 | 138 | 584 | 87.1 | 70 |
| Example 1 | | | | | |

It can be seen from the above table that the density of the copper sheet-embedded soft magnetic powder core inductor of the present application ranges from 5.5 g/cm³ to 6.5 g/cm³ and is significantly higher than that of the ferrite inductor in Comparative Example 1. It can be seen from the comparison of Example 1 and Comparative Example 1 that under the same inductance, the volume of the copper sheet-embedded soft magnetic powder core inductor in Example 1 is about a quarter of the volume of the ferrite inductor in Comparative Example 1. Moreover, the copper sheet-embedded soft magnetic powder core inductor in Example 1 has higher efficiency than the ferrite inductor in Comparative Example 1 when they are applied to the low-voltage DC/DC converter circuits.

It can be seen from the comparison of Examples 1 and 4 to 6 that when the annealing temperature is 550-680° C., the obtained copper sheet-embedded soft magnetic powder core inductor has higher efficiency when applied to the low-voltage DC/DC converter circuits.

The applicant has stated that the above examples are only specific embodiments of the present application, and the protection scope of the present application is not limited thereto.

1. A copper sheet-embedded soft magnetic powder core inductor, comprising:
a copper sheet,
a soft magnetic material covered on a surface of the copper sheet, and
an insulating resin material contained on an interface between the copper sheet and the soft magnetic material.

2. The copper sheet-embedded soft magnetic powder core inductor according to claim 1, wherein the soft magnetic material in the copper sheet-embedded soft magnetic powder core inductor has a density of 5.5-6.5 g/cm³.

3. The copper sheet-embedded soft magnetic powder core inductor according to claim 1, wherein the soft magnetic material is obtained through soft magnetic metal powder subjected to press molding.

4. A method for preparing the copper sheet-embedded soft magnetic powder core inductor according to claim 1, the method comprising the following steps:
(a) coating an insulating resin material on a surface of a copper sheet, baking and curing; and
(b) placing the copper sheet coated with the insulating resin material and obtained in step (a) in soft magnetic metal powder, press molding, and annealing in an inert atmosphere to obtain the copper sheet embedded soft magnetic powder core inductor.

5. The method according to claim 4, wherein the soft magnetic metal powder in step (b) has an average particle size of 2-25 μm.

6. The method according to claim 4, wherein the annealing in step (b) is carried out at a temperature of 550-700° C.

7. The method according to claim 4, wherein the insulating resin material in step (a) comprises an organosilicon resin material.

8. The method according to claim 4, wherein the press molding in step (b) is carried out at a pressure of 12-18 T/cm².

9. The method according to claim 4, wherein the inert atmosphere is nitrogen.

10. A method for preparing the copper sheet-embedded soft magnetic powder core inductor according to claim 1, the method comprising the following steps:
(a) coating an organosilicon resin material on a surface of a copper sheet, baking and curing; and
(b) placing the copper sheet coated with the organosilicon resin material and obtained in step (a) in soft magnetic metal powder with an average particle size of 10 μm, press molding at a pressure of 12-18 T/cm² to obtain a molded body, and placing the molded body in an annealing furnace for annealing at 550-700° C. in an inert atmosphere for 1-3 hours to obtain the copper sheet-embedded soft magnetic powder core inductor.

11. A low-voltage DC/DC converter circuit comprising the copper sheet-embedded soft magnetic powder core inductor according to claim 1.

12. The copper sheet-embedded soft magnetic powder core inductor according to claim 3, wherein the soft magnetic metal powder comprises any one selected from the group consisting of iron powder, iron-silicon powder, iron-silicon-aluminium powder, iron-nickel powder, iron-nickel-molybdenum powder, and a combination of at least two selected therefrom.

13. The copper sheet-embedded soft magnetic powder core inductor according to claim 1, wherein the insulating resin material comprises an organosilicon resin material.

14. The method according to claim 4, wherein the annealing in step (b) is carried out for 1-3 hours.

15. The method according to claim 4, wherein the soft magnetic metal powder in step (b) comprises any one selected from the group consisting of iron powder, iron-silicon powder, iron-silicon-aluminium powder, iron-nickel powder, iron-nickel-molybdenum powder, and a combination of at least two selected therefrom.
